(19) United States
(12) Patent Application Publication
(10) Pub. No.: US 2016/0242611 A1
(43) Pub. Date: Aug. 25, 2016

(54) VACUUM LIQUID SEPARATOR AND METHOD FOR ITS USE

(71) Applicant: PVS ENTERPRISES, INC., Bend, OR (US)

(72) Inventor: Robert Scott Moore, San Jose, CA (US)

(21) Appl. No.: 15/052,760

(22) Filed: Feb. 24, 2016

Related U.S. Application Data
(60) Provisional application No. 62/120,131, filed on Feb. 24, 2015.

(51) Int. Cl. A47L 9/18; B01D 45/08

(52) U.S. Cl. CPC A47L 9/18; B01D 45/08

(57) ABSTRACT

The present disclosure relates to systems and methods for separating liquid from a vacuum filter. An example embodiment of the vacuum liquid separator is provided wherein the liquid separator comprises a cover inclusive of an output port, one or more input ports coupled to an elongated downpipe comprising one or more port holes; a manifold system including a crossover pipe and two 90 degree elbow joints; a vacuum source communicatively coupled to the output port; and at least one tank for holding captured material.

### CROSS-REFERENCE TO RELATED APPLICATION

The present application claims priority to U.S. Provisional Patent Application No. 62/120,131, entitled “VACUUM WATER SEPARATOR METHOD AND APPARATUS,” filed on Feb. 24, 2015, the entire contents of which are hereby incorporated by reference for all purposes.

### FIELD

The present disclosure relates generally to systems and methods for separating liquids from a vacuum filter.

### BACKGROUND

Currently, a variety of vacuum cleaners capable of effectively picking up both wet and dry materials are available on the market. Such devices may be found in a variety of forms, but most generally comprise a large holding tank inclusive of vacuum unit mounted on the top of the tank. Dry or wet materials may then be drawn through a hose and into the holding tank during operation. These types of vacuum cleaners are commonly referred to as “wet/dry vacuums,” or “shop vacuums.”

Wet/dry vacuums typically include a vacuum unit comprising a motor operated blower for creating a negative pressure providing suction of debris into a tank. The debris captured in the tank may then be held at the bottom of the tank while air is exhausted through a filter and subsequently an exhaust port.

In a case of picking up dry material, it may be important for dust captured and routed into the tank of the wet/dry vacuum to not be blown into the air outside of the tank through the vacuum system's exhaust. In order to avoid such a situation, most wet/dry vacuums comprise some sort of filter mounted between the tank and the exhaust so as to contain dry dust contamination within the vacuum's tank. Common filters used in these types of vacuums may typically comprise a flat or pleated paper filter that is attached to the base of the suction creating vacuum unit at the top of the tank.

A common complaint among users of wet/dry vacuum systems is that the typical paper filters mentioned above may not be suitable for use with wet materials. For example, when the common wet/dry vacuum filters are exposed to water or just wet materials such as wet debris, the water may tend to wet the paper filters such that they are quickly rendered unusable under the pressures of typical vacuum operation.

The process of wet material pickup may be further complicated by a number of other factors. For example, while wet dirt and the like may be inclined to stay in the tank and not become mixed into the exhaust of the vacuum, the cleaning of mixed wet and dry materials without a filter in place may usually lead to dust being expelled from the exhaust. Additionally, in instances where only a liquid is being collected, the liquid may tend to become at least partially aerosolized and the aerosol may be exhausted from the vacuum unit. Another complication faced by typical wet/dry vacuum filters may be that most wet/dry vacuums include a cut-off valve in order to prevent liquid from being drawn through the vacuum unit in the event that the tank fills to capacity with liquid. However, these valves may engage at the last minute and may only serve as a last resort precaution. The nature of these cut-off valves may result in spilling or expelling some liquid from the vacuum cleaner.

There have been some attempts to address the issue of filters becoming wet and affecting the usage and operation of wet/dry vacuums such as providing a hydrophobic filter. One such example as shown in U.S. Pat. No. 5,783,086 employs a hydrophobic and air permeable filter material such as PTFE. However, the inventor herein has identified potential issues with such a filter. For example, the hydrophobic filters may be expensive to purchase and replace relative to their traditional paper counterparts. Expensive filters may not be well suited for wet/dry vacuum systems that are used regularly because all filters need to be replaced at some point.

### SUMMARY

In order to address the issues noted above, a device for separating water or other liquids from a vacuum chamber and a method for its use are provided.

In some embodiments, the device may comprise a top cover portion and a tank or container. The cover and the container may form or define a sealed and air-tight chamber under negative pressure. The cover may comprise an output port and one or more input ports. The output port may be coupled to a negative pressure providing source such as a vacuum system via a hose or tube.

The input port(s) may be coupled to a head of a cleaning tool such as a vacuum cleaner adaptor or brush heads via a hose or tube in one example embodiment. Further, some embodiments may include an input port comprising an elongated extended member such as an extended perforated tube that extends inside the container from the cover.

The elongated member, in some example embodiments, may comprise one or more holes on a side face of the elongated member. The elongated member may serve to prevent liquid being sucked into the vacuum system that provides a negative pressure. The holes in the elongated member may further serve to avoid percolation problems within the container that may dampen or damage the filters provided on the vacuum system. In one embodiment, the one or more holes of the elongated member may be oriented such that they are directed away from the output port.

### BRIEF DESCRIPTION OF THE FIGURES

FIG. 1 illustrates a top-down view of a first embodiment of a cover component for a vacuum liquid separator.

FIG. 2 shows a top-down view of a cover component for a vacuum liquid separator including a manifold system, an input port and an output port.

FIG. 3 provides a front side profile view of the vacuum liquid separator cover and manifold assembly.

FIG. 4 shows a top-down view of a second embodiment of a cover component for a vacuum liquid separator.

FIG. 5 shows a top-down view of a second embodiment of a cover component for a vacuum liquid separator including an output port and an input port.

FIG. 6 illustrates a side profile view of a second embodiment of a vacuum liquid separator.

FIG. 7 illustrates a third embodiment of a cover component for a vacuum liquid separator.

FIG. 8 shows a barbed hose fitting member for a vacuum liquid separator in a front isometric view.

FIG. 9 illustrates a down tube for use with a vacuum liquid separator in a side profile view.

FIG. 10 shows a retaining ring for use in a vacuum liquid separator in a side profile view.

FIG. 11 shows a side isometric view of a two stage vacuum liquid separator.

FIG. 12 shows a top-down view of a two stage vacuum liquid separator.

FIG. 13 shows a side isometric view of a cover component for a two stage vacuum liquid separator.

FIG. 14 shows an embodiment of a single stage vacuum liquid separator.

FIG. 15 shows a top-down view of an embodiment of a single stage vacuum liquid separator.

FIG. 16 shows a side isometric view of a cover component for a single stage vacuum liquid separator.

### DETAILED DESCRIPTION

The present description relates to a device and method for separating water or other liquids within the tank or container of a wet/dry vacuum system. The device and method may further be adapted to keep water or other liquid from dampening the vacuum filter which, in turn, may reduce the vacuum's efficiency and suction.

The device may be of further usefulness by keeping the vacuum chamber itself dry, which may enhance the vacuum motor's longevity due to less restrictive forces encountered by the vacuum system.

In one embodiment, the device may allow a shop or individual user the opportunity to use a typical or existing wet/dry vacuum in situations involving a large amount of liquid such as in liquid extraction from carpets during the process of carpet cleaning. In this way, a user may be able to perform duties that may have previously required multiple changes of the vacuum's tank and/or filter in a quick and efficient manner.

As an example, the liquid separator may comprise a cover inclusive of an output port, one or more input ports, and a manifold system coupled to the output port; at least one container or tank; and a vacuum source. The cover may rest atop one or more tanks and may be positioned inline between a standard wet/dry vacuum and the vacuum hose and/or extraction wand. The liquid separator may be used with or without an extraction wand as well as just a vacuum hose in order to pull water.

One embodiment of the vacuum liquid separator may comprise a two-stage system including two containers also referred to herein as “tanks” or “buckets.” Each tank may further include a cover which may comprise an output port for connection to a vacuum source, one or more input port, and an elongated member extending from the cover down into the tank. The elongated member also referred to herein as a “downpipe” or “diffuser pipe” may further include one or more holes to prevent liquid from breaching the negative pressure providing vacuum system.

In embodiments comprising a two-stage system, the use of two tanks may increase the capacity of the vacuum cleaner as a whole and may provide additional protection to the vacuum unit by preventing water from entering the vacuum itself. Additionally, since these embodiments incorporate two tanks, the second tank, referring to the tank downstream of the first relative to the flow supplied by the vacuum, may not need to be emptied as frequently as the main tank or other wet/dry vacuum systems comprising only a single chamber.

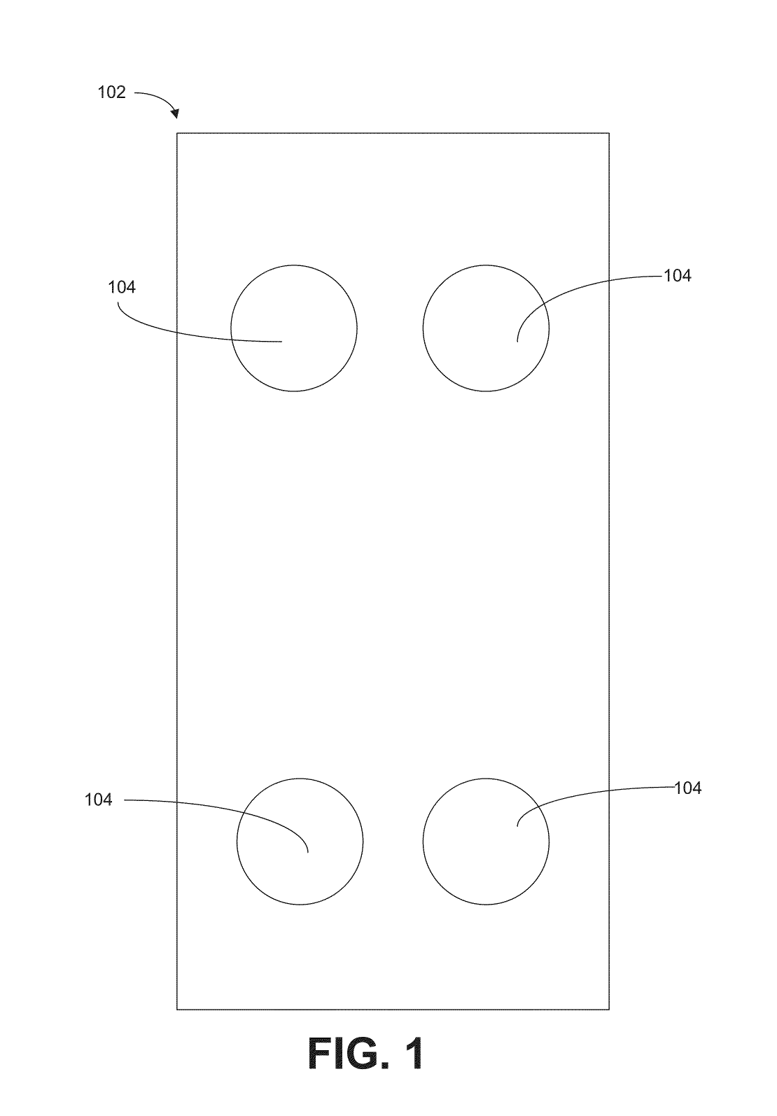

Turning now to FIG. 1, this figure illustrates a first example embodiment of a cover component 102 of the vacuum liquid separator 100. In this embodiment, the cover component 102 may comprise a planar surface into which one or more holes 104 may be drilled. The hole(s) 104 drilled into the planar surface of the cover may provide for one or more of an input port, an output port or ports, and a manifold inclusive of a cross over tube as illustrated in subsequent figures.

In embodiments comprising more than one hole in the cover component, the holes may be substantially in line with one another. For example, in cases in which two holes are made, the centers of each hole may be aligned along a common central axis. It will be appreciated that embodiments provided herein may exhibit an even number of holes in cases where more than one hole is present in the cover component. However, other variations of the cover component such as cases in which the number of holes is odd are equally envisioned.

In embodiments comprising a two-stage system for example, the number of holes drilled into the cover component may be four or more. In this way, a cover component is provided enabling the inclusion of an input port, an output port, and a crossover tube connecting one tank or “stage” to another tank.

One example embodiment of the present disclosure may comprise a cover constructed of a ⅜ inch thick “cast” plexiglass roughly 13 inches wide and 26 inches long. The cover may comprise a substantially rectangular shape in at least one embodiment. This piece of plexiglass may necessitate cutting with a table saw or other suitable cutting medium from a standard 4 foot by 8 foot preformed sheet of plexiglass.

Once a cover component is cut out, one or more holes may then be cut into the plexiglass sheet. In one embodiment, four holes may be cut into the cover portion using a drill press with a hole saw or any other suitable hole drilling method. In one embodiment, the holes in the cover component may comprise a substantially round profile having roughly a 3 inch diameter.

As an example, the cuts made in the cover component may be made via cutting into a plexiglass sheet slightly deeper than half of the width of the plexiglass sheet. Once a cut has been made a little over halfway through the sheet, the sheet may then be turned over and the remaining material may be cut. In this way, a smoother finish substantially free of burrs or barbs may be achieved.

In one embodiment, the holes in the cover component may comprise a diameter of about 3 inches. Some embodiments may comprise holes that are equally spaced from the peripheral edge of the cover. Further, in some embodiments, the distance of the holes from the peripheral edge of the cover may be equal to the diameter of the holes. For example, in the embodiment illustrated in FIG. 1, the holes may comprise a 3 inch diameter wherein the center of each circular hole 104 may be about 3 inches from a side peripheral edge of the planar surface. The holes 104 in one embodiment may further be disposed at a distance of about 6.5 inches from a front or rear peripheral edge of the planar surface. Additionally, the center of each hole may be spaced horizontally apart from one another at a distance of about 7 inches. In the embodiment shown in FIG. 1, the center of each hole may further be spaced about 13 inches from one another such that two tanks may be provided below the cover component 102.

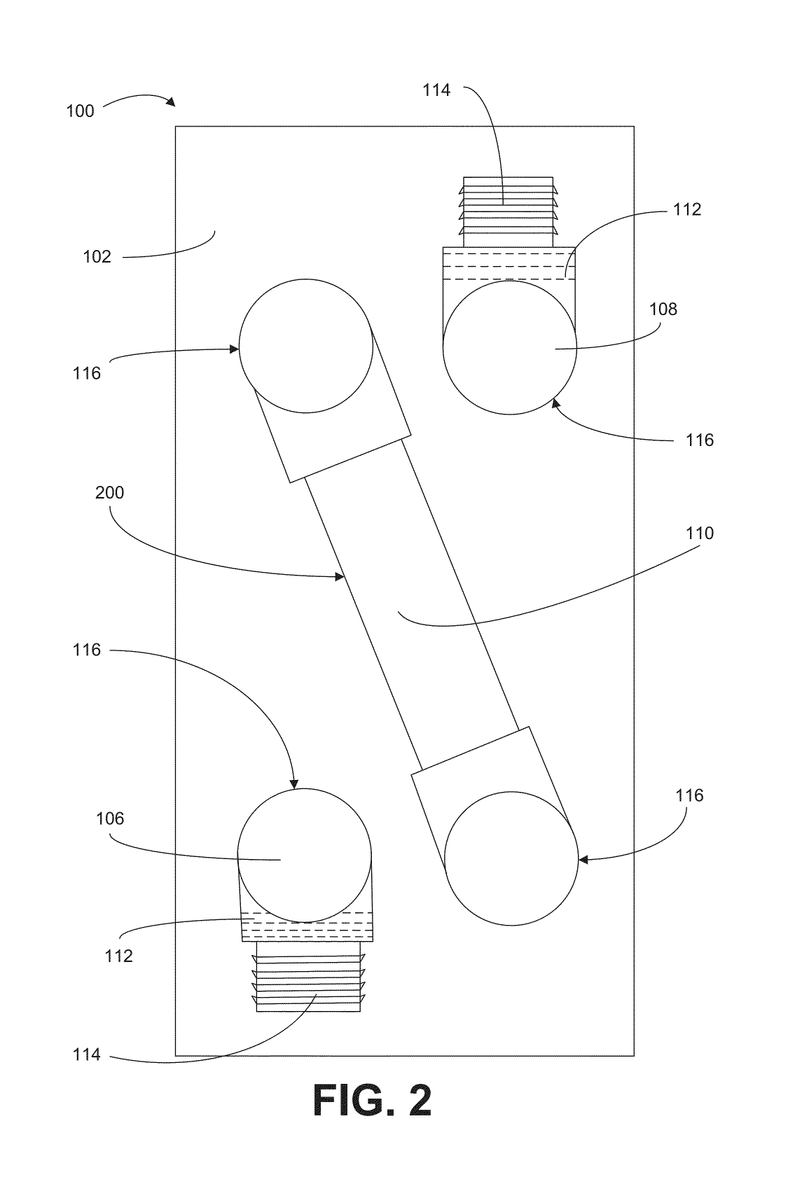

With respect to FIG. 2, this figure shows a top-down view of a cover component 102 for a vacuum liquid separator 100 including a manifold system 200, an input port and an output port. In one embodiment, the cover component 102 may comprise a planar surface including one or more holes 104 as illustrated in FIG. 1.

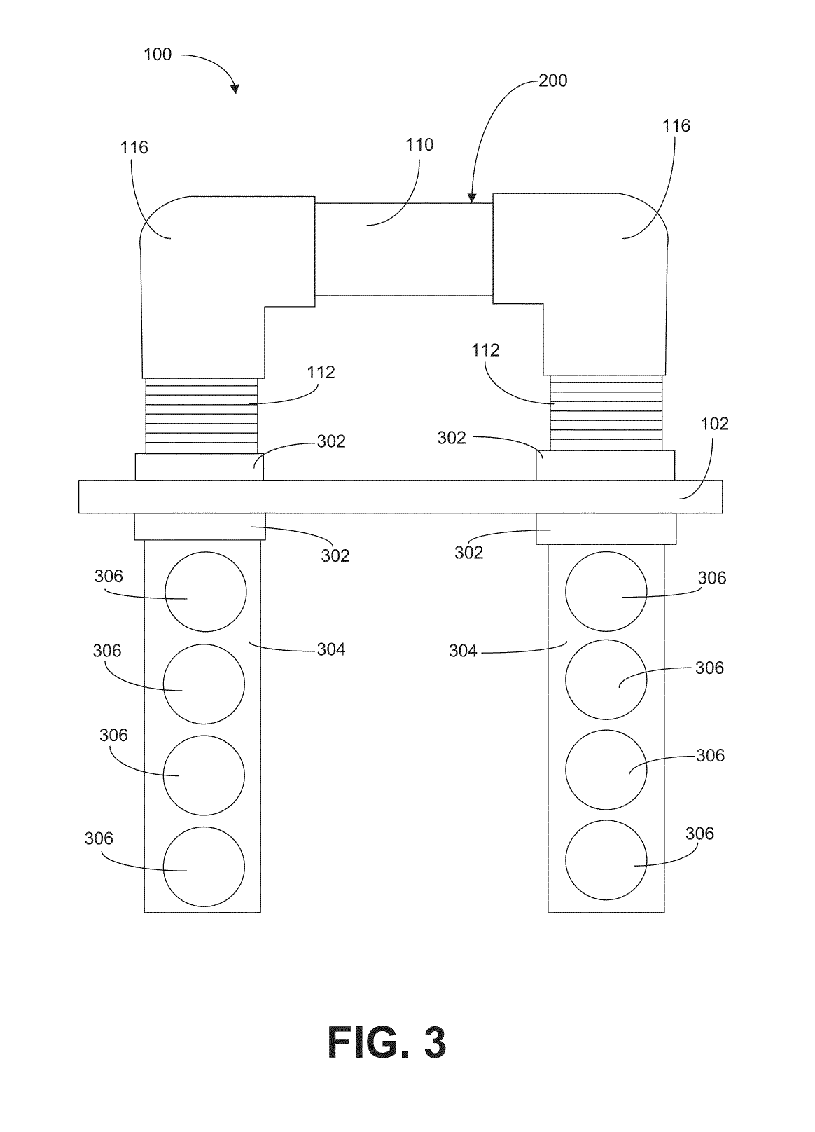

The manifold system 200 provided in FIG. 2 may comprise a crossover tube 110 retained by two 90 degree elbow joints 116 connecting two holes 104 to each other. In this way, an exchange channel from one tank or stage to a second tank or stage may be provided. The 90 degree elbow joints 116 of the manifold system 200 may each additionally be coupled to an elongated member referred to herein as a downpipe (shown in FIG. 3).

In order to couple the downpipes to the manifold system in one embodiment, once the holes 104 are cut, bulkhead fittings may be attached to the planar surface of the cover component 102 such that the bulkhead fittings fully traverse the planar surface. In this way, a seal on each of a top face and bottom face of the cover component 102 may be achieved. The bulkhead fittings may be positioned with a threaded extension facing upward through the planar surface of the cover component 102 such that a user may more easily observe a problem such as a leak if one were to occur. The orientation of the bulkhead fittings where the threads are directed upward and out of the vacuum chamber may further allow for a smaller portion of the bulkhead fittings to be present in the vacuum chamber which may increase the capacity of the chamber.

Once the bulkhead fittings are installed, each bulkhead fitting may then be coupled to the 90 degree elbow joints 116. In one embodiment, the bulkhead fittings may be coupled to the elbow joints 116 via using a length of schedule 40 PVC piping that may be cut to fit the application and de-burred. The bulkhead fittings and the PVC pipe portions may then be primed and glued into place using PVC cement or another suitable adhesive.

In one embodiment, from the top of the cover component 102, the coupled bulkhead fittings and PVC pipe portions may then be primed and glued before being pressed down halfway into the planar surface of the cover. In this way, an interface connecting the interior of the vacuum chamber to an exterior is provided.

Once the elbow joints 116 are secured into place in the cover component 102, the crossover tube 110 may be attached to two of the 90 degree elbow joints 116 in a diagonal orientation. In one example embodiment, the crossover tube 110 bay comprise a 2 inch diameter and 11.5 inch long section of schedule 40 PVC pipe. If the section of PVC pipe used for the crossover tube 110 is cut to fit between two elbow joints 116, the pipe may be de-burred prior to coupling to the elbow joints. In this way, a more reliable and effective seal may be established between the two components.

When coupling the crossover tube 110 to the elbow joints 116, a type of fitting referred to as a slip-to-slip fitting may be used in at least one embodiment. The slip-to-slip fittings may be primed and glued into place on one side to the crossover tube 110 and on the other to a respective 90 degree elbow joint 116. In one embodiment, the crossover tube may be connected to opposite corners of the cover component 102. As one example, the elbow joints 116 and the crossover tube 110 may be assembled by gluing each component and sliding them together quickly while being pressed down onto their corresponding bulkhead fittings.

In an example embodiment in which four holes are present in the cover component 102, two holes may be occupied by a manifold system 200 and the remaining two holes may comprise an input port 106 and an output port 108. In order to be utilized as input and output ports, a slip to FNPT (Female National Pipe Thread) fitting may be placed into the void space of the 90 degree elbow joints 116. The slip to FNPT fittings may then be secured using a primer and a suitable PVC adhesive compound. In one embodiment, the slip to FNPT fittings may be disposed on opposite ends of the cover 102 such that they face their respective end and are directed away from one another. It will be appreciated that the threading 112 of some components of the vacuum liquid separator are shown via a broken line in the figures.

Once the slip to FNPT fittings are secured within the elbow joints 116, two barbed MNPT (Male National Pipe Thread) fittings 114 may be screwed into the FNPT fittings. The junction between the MNPT fittings and the FNPT fittings may further be reinforced in at least one embodiment via the use of Teflon tape. The two fittings may then be screwed together by hand since the fittings comprise threading 112 corresponding to one another and the Teflon tape may provide an air-tight fitting.

Turning now to FIG. 3, this figure provides a front side profile view of the vacuum liquid separator cover and manifold assembly. In this view, the downpipes 304 of the vacuum liquid separator are visible. The downpipes 304 may comprise one or more port holes 306 disposed along a front edge of the downpipe 304 relative to the cover component 102.

In one embodiment, the downpipes 304 may be coupled to the cover 102 via a bulkhead fitting 302. The bulkhead fitting 302 may fully traverse the planar surface of the cover component 102 such that an extension of the bulkhead including threading 112 may be directed upward relative to a ground surface and out of the vacuum chamber. The threaded 112 portion of the bulkhead fitting 302 may then be coupled to a manifold system 200. The manifold system may comprise two 90 degree elbow joints 116 connected to one another via a crossover tube 110 in one embodiment.

In one embodiment, the downpipes 304 may comprise 2 inch diameter PVC pipe sections about 8 inches long. In some cases, the downpipe 304 sections may need to be cut and subsequently de-burred. In a further example embodiment, the downpipes 304 may comprise four 1 inch port holes 306 disposed along a front or rear face of the downpipe 304 relative to the positioning of the cover component 102. Further, starting from one end of the downpipe 304, a first port hole 306 may be drilled about 1.5 inches on center from the end of the PVC tube section. In an embodiment comprising more than one port hole 306, the remaining holes may be drilled 1.5 inches on center upward along the pipe 304 in a straight vertical line.

In one embodiment, the drilling of port holes 306 may be performed using a drill press equipped with a 1 inch forstner bit for example. In the case in which a forstner bit is used to drill the port holes 306 into the downpipe 304, the bit may allow for substantially smooth holes in which secondary de-burring may not need to be performed. In other embodiments, the drilling of port holes 306 may be completed via any other suitable method for drilling into PVC.

In order to secure the downpipes 304 to the cover 102, side may be chosen to be a side common to each downpipe 304. For example, in some embodiments, four holes 104 may be placed into the cover 102 and two of the holes may be occupied by a manifold system 200, and the remaining two holes may be occupied by an input port and an output port. In some embodiments, the manifold system 200 may comprise one downpipe 304 and an input port may comprise a single downpipe 304. Specifically, when viewing the vacuum liquid separator from the side, since the manifold system 200 comprises two holes connected to one another via crossover tube 110; two downpipes 304 may be installed on the same side of the cover component 102.

Once a side has been chosen as the side common to both downpipes 304, the ends of each downpipe 304 that will be attached to the bulkhead fittings 302 may be primed and glued to a portion of the bulkhead fitting 302 on an internal surface of the cover 102 directed toward the vacuum chamber. In one embodiment, the port holes 306 in the downpipes 304 may be oriented such that they face the nearest edge of the planar surface of the cover component 102.

After one downpipe 304 is coupled to the cover component 102, a second downpipe may be installed on the same side of the cover 102. The two downpipes 304 may correspond to two different and distinct tanks or containers. In this way, a two or more stage water separation device may be provided.

In one embodiment, the cover component 102 may comprise a manifold system 200 that connects two holes of a four hole cover in a diagonal manner such that only one end of the manifold system comprises a downpipe 304. The remaining two holes of the cover 102 in such an embodiment may comprise an input port 106 which may then be connected to a vacuum hose or wand. The input port 106 may serve as the fluid inlet side. The final remaining hole of this embodiment of a vacuum liquid separator may additionally include an output port 108 that may be coupled to a vacuum system such as a typical wet/dry vacuum.

An example technical effect of providing port holes 306 in the downpipes 304 that may be directed toward the nearest side of the planar surface of the cover component 102 is that the amount of airborne or aerosolized water that may migrate over to the vacuum side of the device may be reduced. Once both downpipes are coupled to the cover component, the direction and orientation of the port holes 306 may then determine the direction of flow.

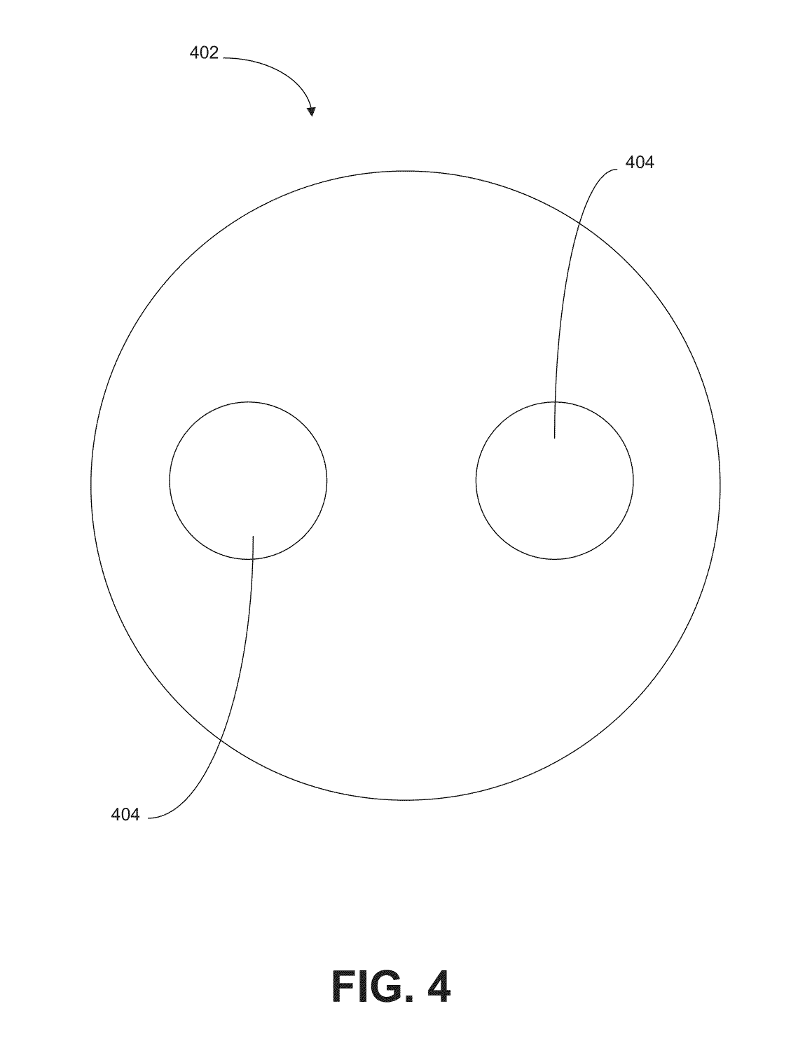

Turning now to FIG. 4, this figure shows a top-down view of a second embodiment of a cover component 402 to be used with a vacuum liquid separator. The cover component 402 in one embodiment may comprise a substantially planar and circular shape constructed of plexiglass or another suitable and durable material. Further, the cover component 402 may additionally comprise one or more holes 404 fully traversing the planar surface of the cover. In this way, a chamber may be formed below the cover component which may further include an input port and an output port.

It will be appreciated that components common to the various different embodiments provided in the figures may be indicated as such through the use of common numeric notation. For example, the 90 degree elbow joints 116 may be identified across various embodiments provided by the figures using the same numeric notation, 116. In this way, common features may be more easily recognizable.

In one example of the embodiment provided in FIG. 4, the cover component 402 may be positioned over a container or tank and may be positioned inline between a standard wet/dry vacuum and the vacuum hose or extraction wand. In one embodiment, the cover component may be placed atop a standard 5-7 gallon bucket or a similar tank configuration. The vacuum liquid separator may be used with an extraction wand or without a wand in order to pick up wet materials or liquids. It will be appreciated that the use and positioning of the vacuum liquid separator may serve to keep water or other liquids from dampening or damaging the vacuum filter. A dampened or damaged vacuum filter may result in a loss or reduction in suction and may further decrease the overall efficiency of the vacuum.

The vacuum liquid separator may be further useful in that the liquid separator may keep the vacuum chamber, defined by the inner surface of the cover component and a tank, dry which may improve the longevity of the vacuum motor due to less restrictive forces encountered by the vacuum unit. The separator may allow a shop or individual user to use an existing or typical wet/dry vacuum to perform liquid extractions such as carpet cleaning with fewer unnecessary tank changes and without damaging or dampening the filter.

One example of the cover component embodiment illustrated in FIG. 4 may comprise a substantially round profile featuring two holes 404 fully traversing the plane of the cover 402. The planar surface of the cover, i.e. the surface into which holes may be cut, may be constructed of a 13 inch diameter and 0.25 inch thick piece of “cast” plexiglass. In some cases, the piece of plexiglass to be used as the cover component 402 may be routed from a standard 4 foot by 8 foot sheet of plexiglass.

In such an embodiment, once the main 13 inch diameter circle is cut, two additional circular holes 404 may be cut into the cover. In one embodiment, the two holes in the plexiglass cover may be cut using a drill press and a 3 inch hole saw bit. It will be appreciated that holes of variable sizes may also be cut into the cover component depending on the size of the hose fittings and/or adapters to be used with the vacuum cleaner.

In one embodiment, holes 404 in the cover component may be formed by cutting just over halfway through the planar surface of the cover 402 and then turning it over and cutting through the remainder of the surface from the other side. In this way, a substantially smooth finish of the holes 404 may be achieved. In one example embodiment, the holes may be 3 inches in diameter and may be 3 inches on center from the edge of the cover. In one embodiment, the cover component 402 may comprise a 13 inch diameter round shape and two 3 inch holes may be positioned opposite one another such that their centers are about 7 inches apart.

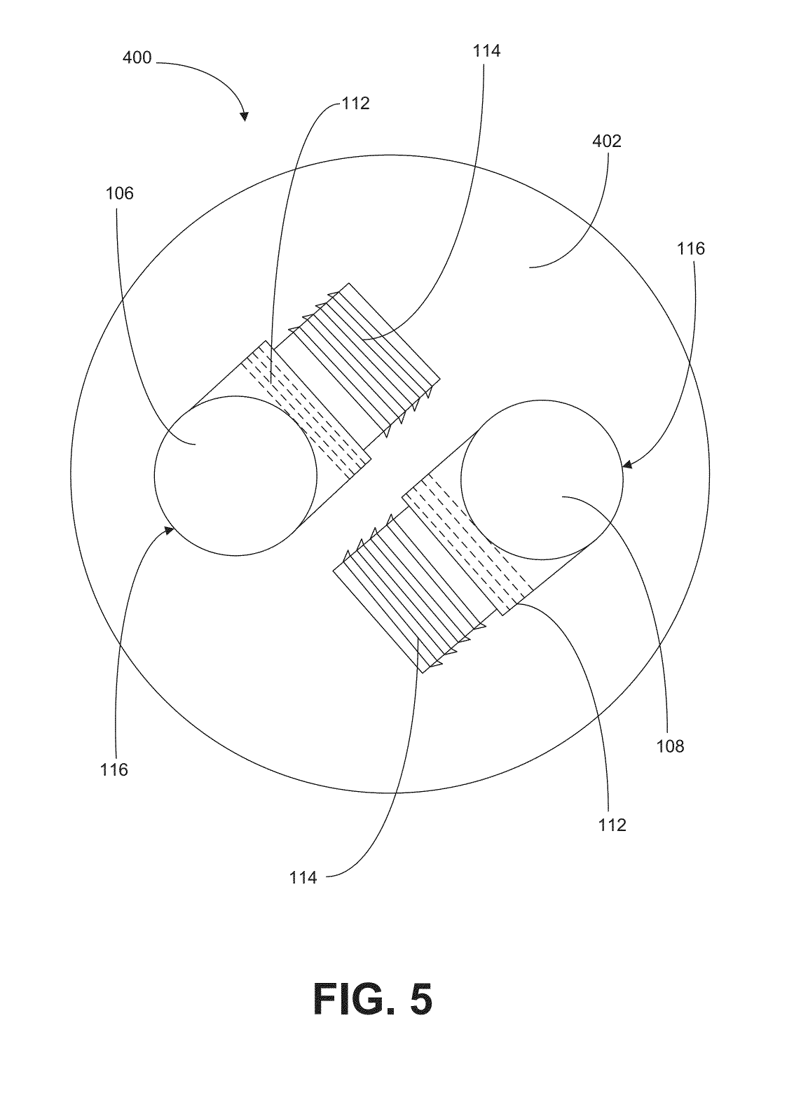

With respect to FIG. 5, this illustration shows a top-down view of a second embodiment of a cover component 402 for a vacuum liquid separator 400 including an output port 108 and an input port 106.

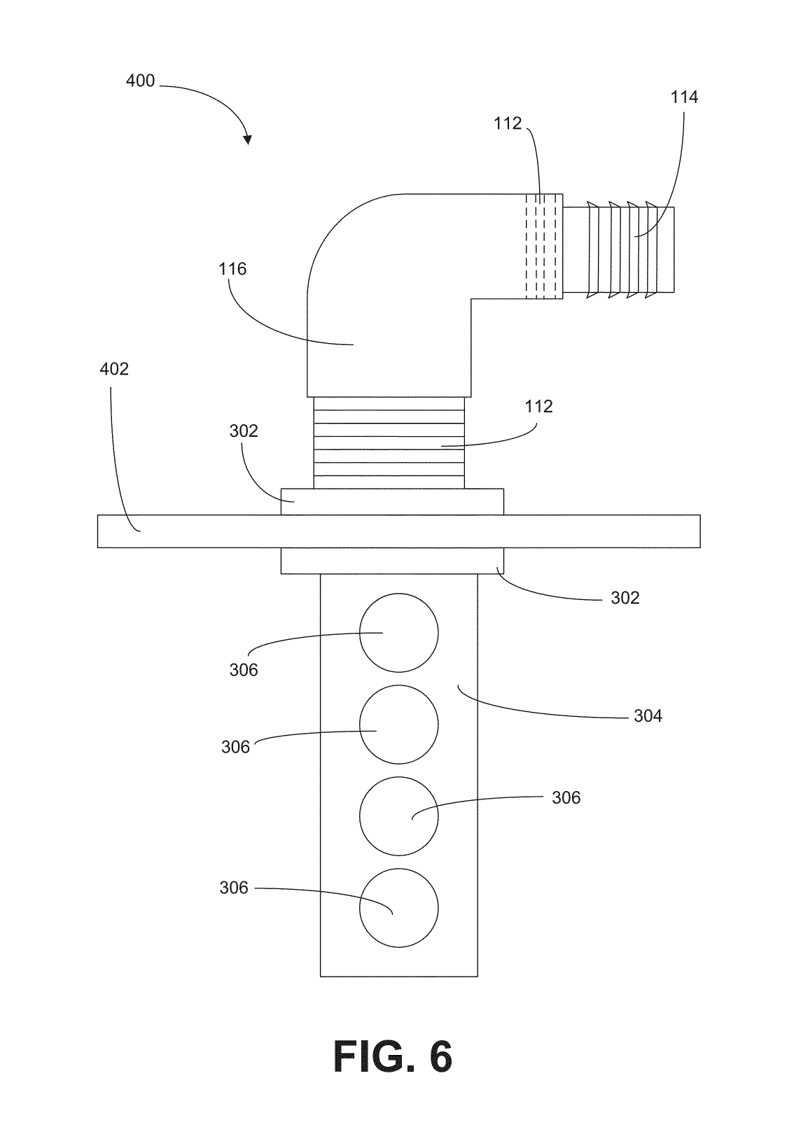

The cover component 402 may further be configured to use as a vacuum liquid separator via the inclusion of at least one downpipe. The downpipe may further be coupled to the cover component via the use of bulkhead fittings which may be more clearly visible in FIG. 6. The downpipe may then be coupled to a 90 degree elbow joint 116. Further, the downpipe and 90 degree elbow coupling may occupy one of the two provided holes 402.

In some embodiments, only a single downpipe may be provided in single stage liquid separators. In this way, an input port 106 coupled to a downpipe may be provided such that an output port 108 may be connected to communicate directly with the vacuum unit. By providing a downpipe on the input port 106, the output port 108 which may be coupled to the vacuum system may be protected against splashing liquids and/or aerosolized liquids.

Turning now to FIG. 6, this figure illustrates a side profile view of the embodiment provided in FIG. 5. In this view, the downpipes 304 of the vacuum liquid separator are visible. The downpipes 304 may comprise one or more port holes 306 disposed along a front edge of the downpipe 304 relative to the cover component 402.

In one embodiment, the downpipes 304 may be coupled to the cover 402 via a bulkhead fitting 302. The bulkhead fitting 302 may fully traverse the planar surface of the cover component 402 such that an extension of the bulkhead including threading 112 may be directed upward relative to a ground surface and out of the vacuum chamber. The threaded 112 portion of the bulkhead fitting 302 may then be coupled to a 90 degree elbow joint 116 via a FNPT to slip fitting.

Once the two holes are cut in one embodiment, two slip to slip bulkhead fittings 302 may be attached to the cover component 402. The bulkhead fittings 302 may then be positioned with their threaded portions facing upward relative to a ground surface and out through the cover 402. In this way, it may be possible for a user to more easily observe a problem such as a leak if one were to occur. Additionally, the treaded portion of bulkhead fittings may comprise a longer extension and the opposite end may be substantially shorter such that its placement on the interior of the vacuum chamber may serve to slightly increase the tank's capacity.

Once the bulkhead fittings 302 are coupled to the cover component 402, two small extensions of schedule 40 PVC pipe may be coupled to the bulkhead fitting 302. If the portions of the PVC pipe to be used must be cut, the sections may then be de-burred to ensure a sufficient adhesion. In one example, the PVC pipe portions and the bulkhead fitting on the interior of the vacuum chamber, as defined by the interior of the containers or tanks and an interior surface of the cover component 402, may be primed and glued into place. As a further example embodiment, PVC pipe sections may be coupled to the portion of the bulkhead fittings 302 that extend upward through the cover component 402.

In such an embodiment, from the top of the cover, the PVC pipe portions may be primed, glued, and subsequently pressed down about halfway into the bulkhead fitting 302. Next, two 90 degree elbow joints 116 may be coupled to the bulkhead fitting via gluing the elbow joints 116 to the PVC extensions coupled to the upward facing threaded 112 portion of the bulkhead fitting 302.

In one embodiment, the 90 degree elbow joints 116 may comprise a slip to FNPT fitting. In order to couple such an elbow joint to a barbed fitting 114 for use with a vacuum hose or extraction wand, both the barbed fitting 114 and the threads 112 of the 90 degree elbow joint 116 may be primed and glued to each other.

As an example, some embodiments may comprise an input port 106 and an output port 108. In such embodiments, it may be expedient to provide 90 degree elbow joints 116 facing each other in a parallel manner such that that hoses connecting to a vacuum system or a vacuum hose may not become entangled.

In some examples, the barbed fittings 114 coupled to the 90 degree elbow joints as shown in FIG. 6, may comprise a barb to MNPT fittings. In embodiments comprising the barb to MNPT fittings, Teflon tape may be used along the threads 112 to provide an airtight seal. When using Teflon tape along the threading 112, the tightness of the components may only be hand tight since the Teflon tape may fill gaps between the threads 112 and may provide a substantially airtight seal.

In one embodiment, the downpipe 304 may comprise an elongated PVC pipe member that may be cut from stock and de-burred. In one example, the downpipe 304 may be 8 inches in length and may comprise one or more roughly one inch holes disposed within an external face of the tube. One embodiment may comprise 4 port holes 306 disposed along an exterior face of the pipes. In order to provide such an embodiment, a first hole may be drilled about 1.5 inches on center from one end of the pipe 304. The remaining three holes may then be drilled about 1.5 inches on center up along the pipe in a straight vertical line.

As an example, the port holes 306 of the downpipe 304 may be cut into the downpipe via a drill press and a forstner bit although any other suitable method of cutting may be applied to this embodiment. The use of a forstner bit however, may provide substantially smooth port holes 306 that may be further substantially free of burrs or sharp extensions.

Once the downpipe 304 has been configured to comprise one or more port holes 306, the downpipe 304 may then be coupled to the portion of the bulkhead fitting 302 directed downward toward the interior of a vacuum chamber. This coupling may be performed via priming and gluing the bulkhead fitting and the downpipe before inserting the downpipe into the slip fitting portion of the bulkhead fitting 302.

Once the downpipe 304 is coupled to the bulkhead fitting 302, the port holes 306 of the downtube may be oriented such that they may face the nearest edge of the cover component 402. After the downpipe 304 is coupled to the cover component 402, the direction of flow may be determined. Specifically, the 90 degree elbow joint 116 coupled to the downtube 304 may comprise an input port which may be used for fluid input. The other 90 degree elbow joint 116 which may not be coupled to a downpipe may then be coupled to a vacuum system. The 90 degree elbow joint coupled to the vacuum system may therefore comprise an output port. In this way, the possibility of liquid or aerosolized liquid coming into contact with the vacuum system may be reduced.

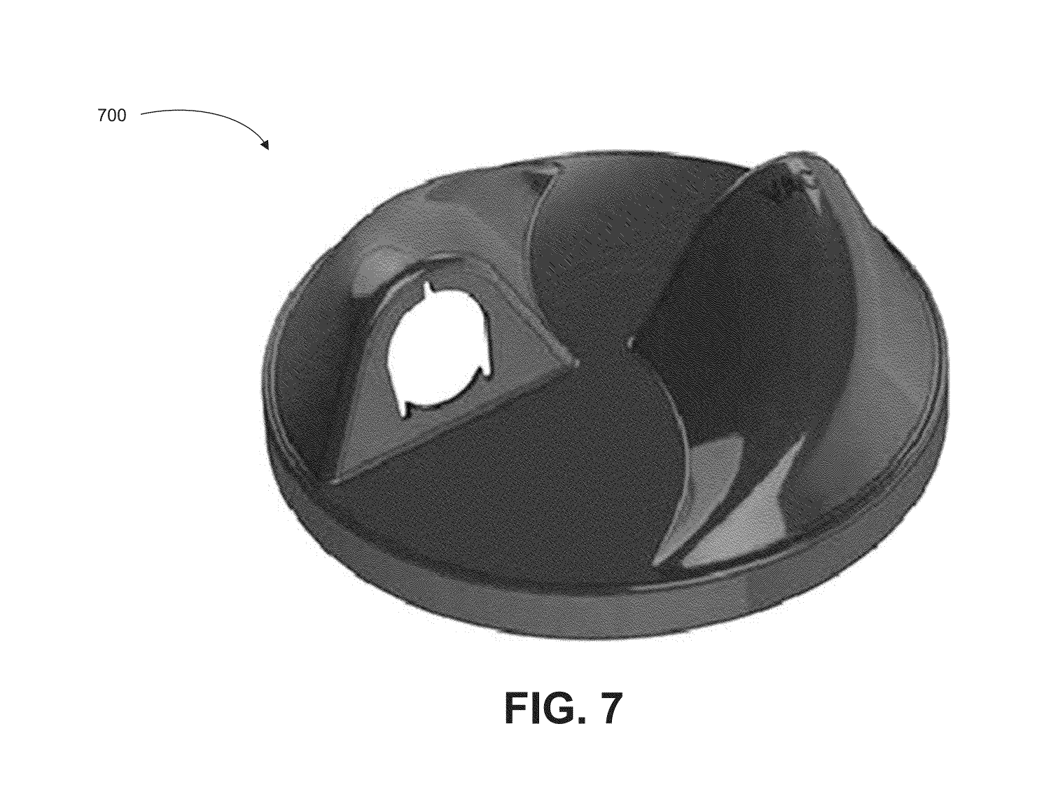

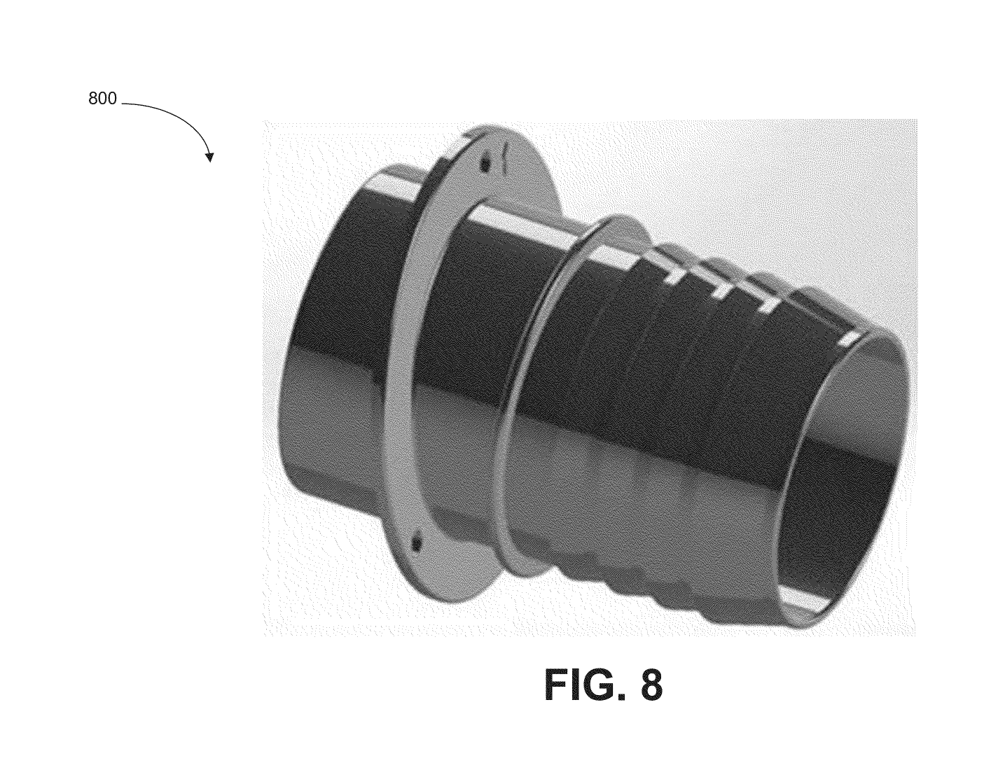

Turning now to FIG. 7, this figure shows an additional example embodiment of a cover component 700 to be used with a vacuum liquid separator. In this example, the construction as described above with reference to FIGS. 1-6 may be simplified. For example, the components illustrated in FIGS. 8-10 may be used in conjunction with one another and may be coupled to one another such that a complex installation/manufacturing process may be removed.

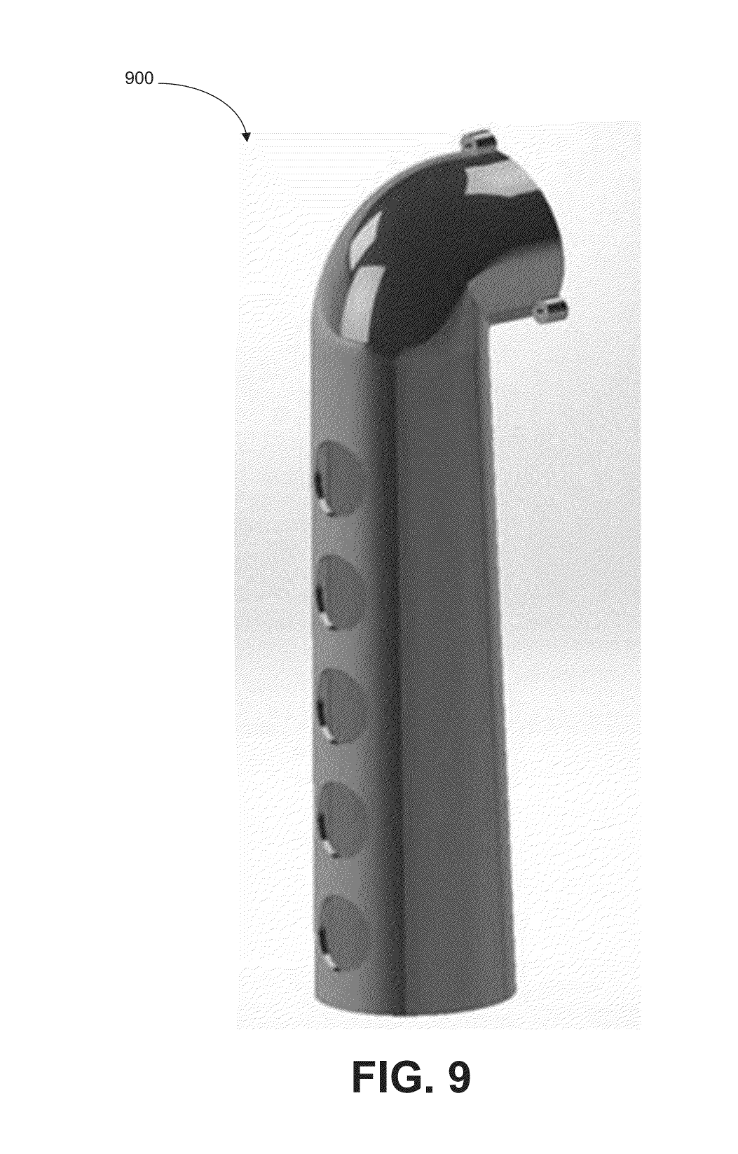

With respect to FIG. 8, a barbed hose fitting member for a vacuum liquid separator is shown. This component may be used in at least one embodiment of the vacuum liquid separator with the downpipe shown in FIG. 9. In this way, the manufacturing/installation process may be simplified slightly. Further, in one embodiment, the components of FIGS. 7-10 may comprise slip to slip fittings such that a simple coupling between the elements may be performed using a primer and glue.

In FIG. 9, an example downpipe configuration is provided. This example embodiment of a downpipe includes a 90 degree elbow joint that may be integral to the downpipe itself. In this way, the cover component of the vacuum liquid separator may be more easily constructed.

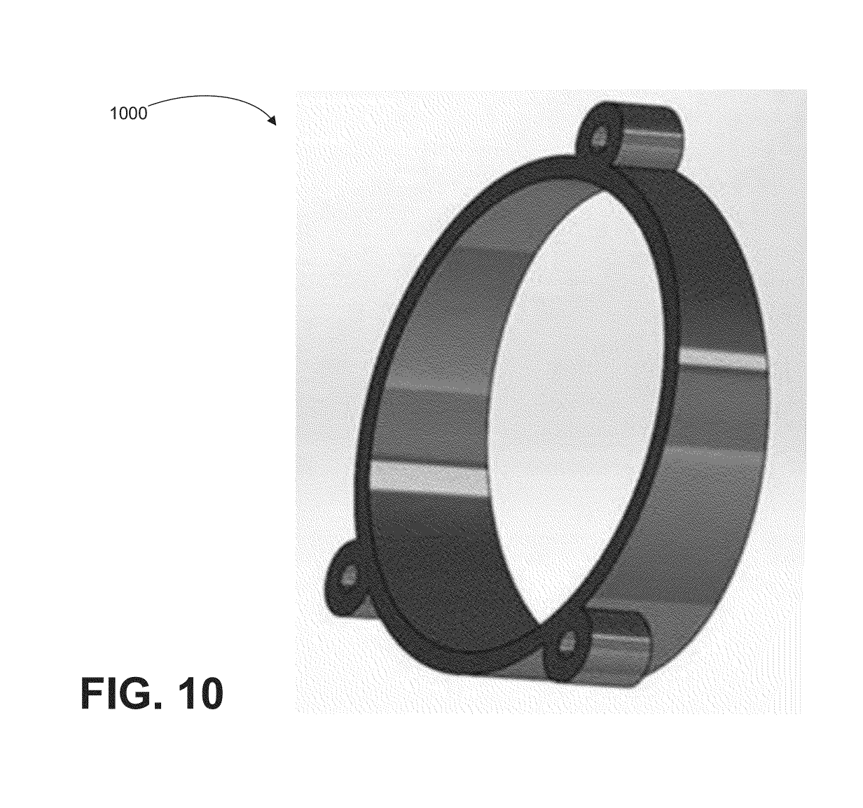

As shown in FIG. 10, a retaining ring 1000 may be used to couple components of the vacuum liquid separator. In one embodiment, the retaining ring 1000 may be used to couple the downpipe of FIG. 9 to the cover component provided in FIG. 7. Additionally, the retaining ring 1000 of FIG. 10 may be used to couple the barbed fitting 800 of FIG. 8 to the end of the 90 degree elbow of the downpipe illustrated in FIG. 9. In this way, the number of components comprising the cover component of the vacuum liquid separator may be reduced.

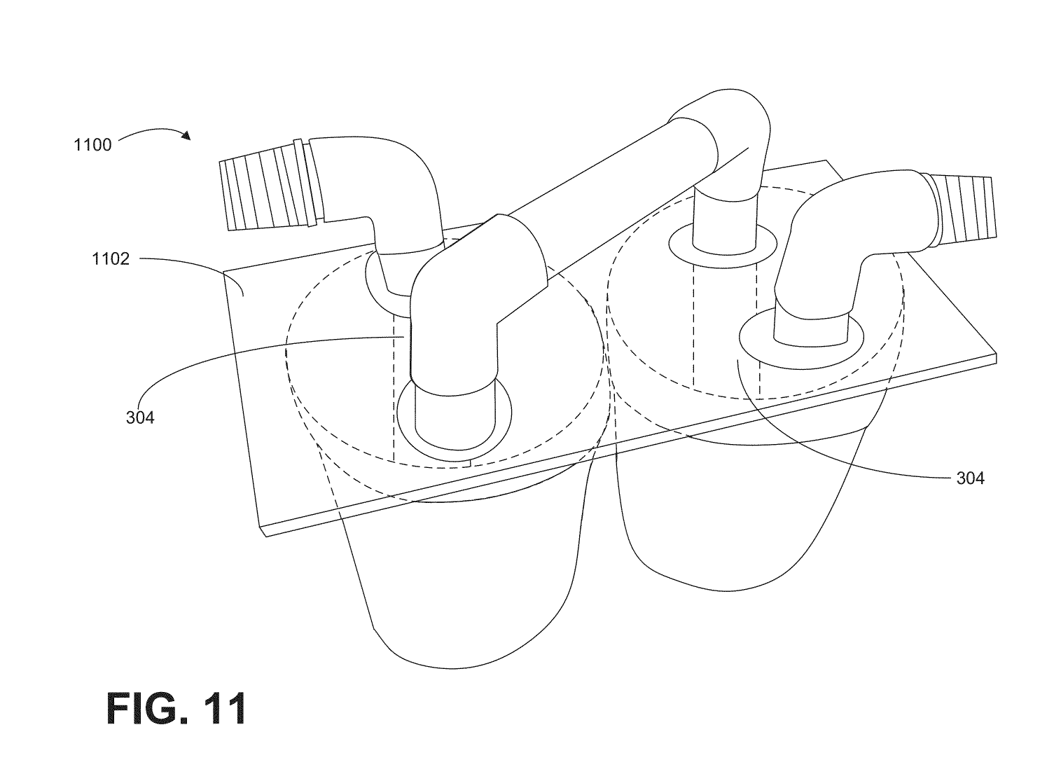

Turning now to FIG. 11, this figure shows a further example embodiment of a vacuum liquid separator 1100 comprising two stages. It will be appreciated that as used herein, the term “stage” or “stages” may be used to refer to the number of tanks provided for retaining captured material. Here it may be visible that the downpipes 304 may be positioned, at least in one embodiment, along a common side of the cover component 1102.

The embodiment illustrated in FIG. 11 may further comprise one or more port holes disposed along a side face of the downpipes 304. In such embodiments however, the holes may be positioned such that they may be directed toward the closest most longitudinal edge of the planar surface of the cover component. In this configuration, it may not be possible to view the port holes of the downpipes 304 from the perspective provided in FIG. 11.

As mentioned above, some embodiments of the vacuum liquid separator may comprise more than one tank for retaining captured material. Such embodiments may be referred to herein as multi-stage or two-stage liquid separators.

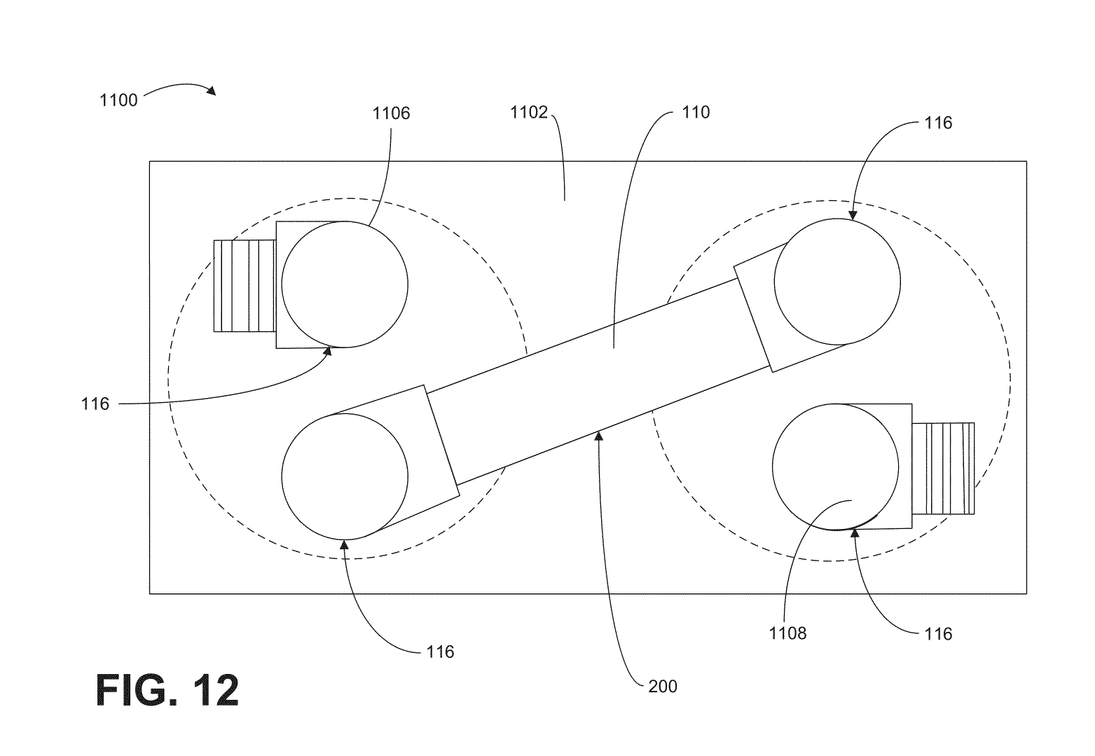

A multi-stage vacuum liquid separator 1100 is illustrated in a top-down view in FIG. 12. This embodiment may comprise a cover component 1102 for a vacuum liquid separator 1100 including a manifold system 200, an input port 116 and an output port 118. In one embodiment, the cover component 1102 may comprise a planar surface including one or more holes into which 90 degree elbow joints 116 may be inserted.

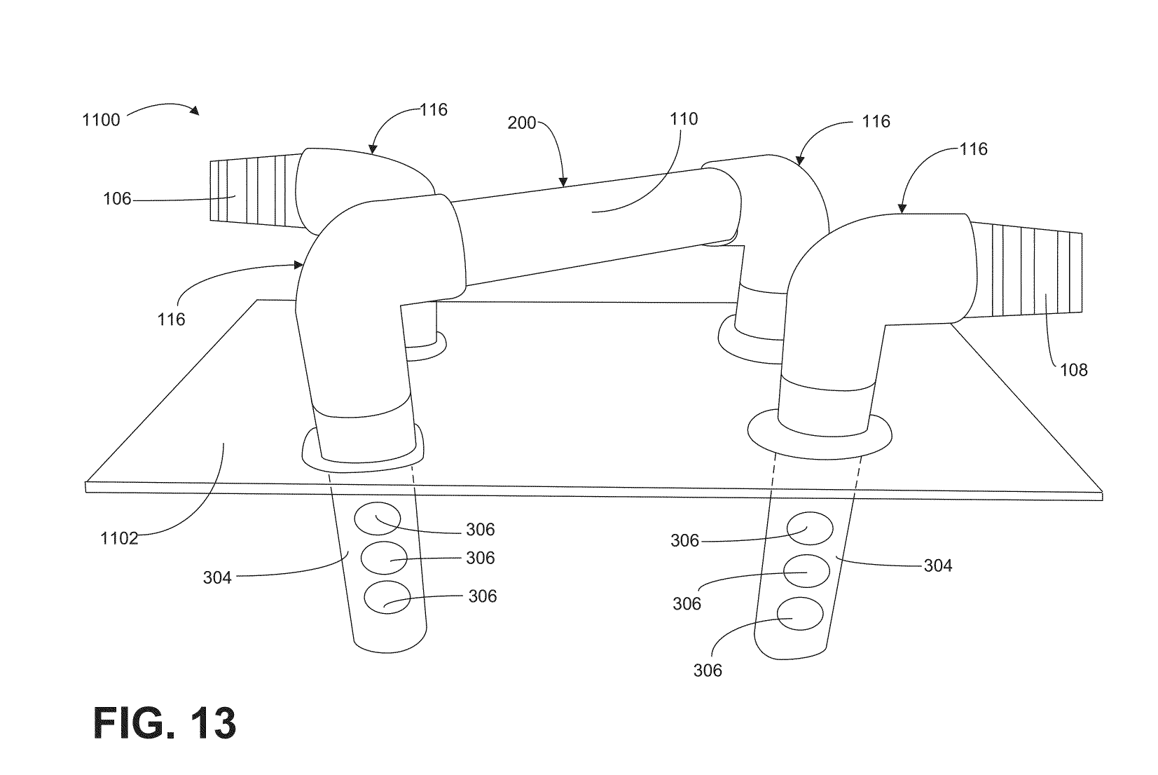

The manifold system 200 provided in FIG. 12 may comprise a crossover tube 110 retained by two 90 degree elbow joints 116 connecting two holes to each other. In this way, an exchange channel from one tank or stage to a second tank or stage may be provided. The 90 degree elbow joints 116 of the manifold system 200 may each additionally be coupled to an elongated member referred to herein as a downpipe (shown in FIG. 13).

In FIG. 13, a side isometric view of an embodiment of a vacuum liquid separator 1100 is provided. The embodiment illustrated in FIG. 13 may be the same embodiment illustrated in FIGS. 11 and 12. In FIG. 13, it may be clearly visible that the downpipes 304 provided in at least one embodiment may share a common side of the cover component.

In other words, the downpipes 304 of the vacuum liquid separator 1100 may fully traverse the cover component 1102. The downpipes 304 may further be arranged along a common plane such that their profiles are substantially parallel to one another and with respect to the longitudinal sides of the cover component.

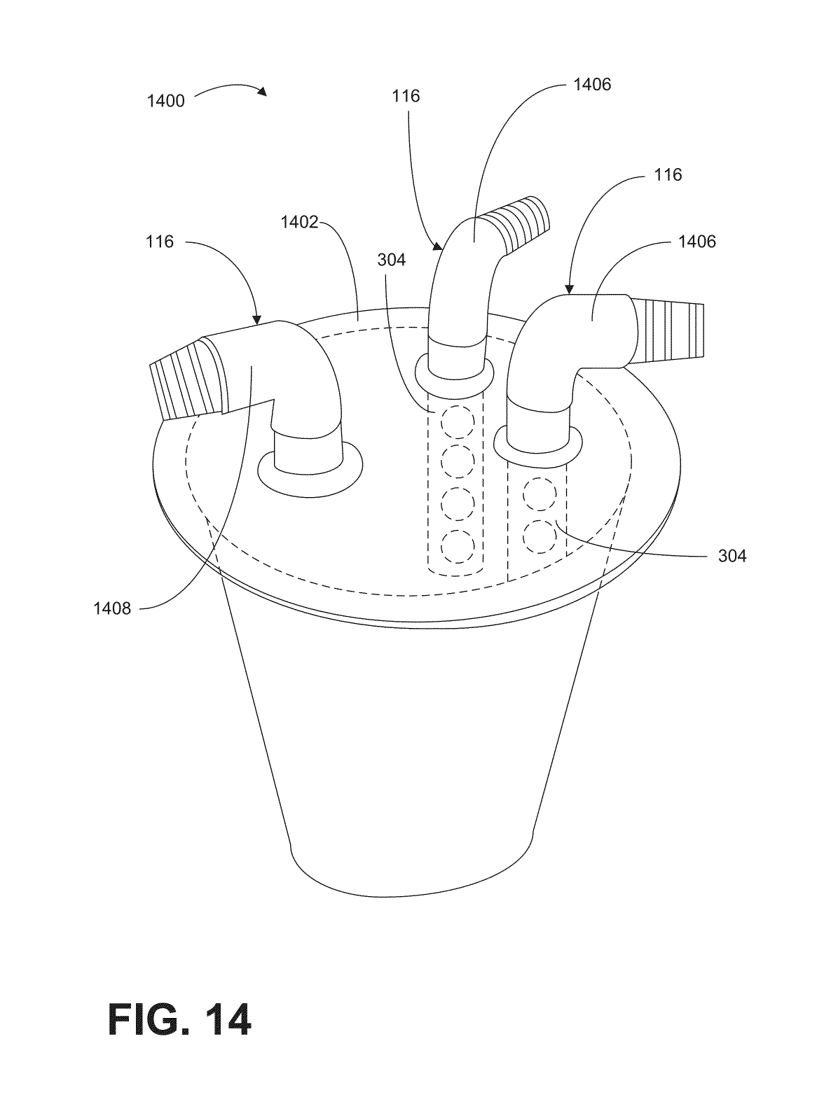

FIG. 14 illustrates an additional example embodiment of a vacuum liquid separator 1400 comprising a single stage defined by a single tank for retaining captured material. In this embodiment, more than one input port 1406 may be provided. In one embodiment, the additional input port(s) may allow for connection of one or more vacuum liquid separators in series or along with other vacuum systems or components.

In one embodiment, the output port 1408 of the vacuum liquid separator may not include a downpipe 304. In such an embodiment, the output port may serve to provide additional protection to the vacuum filter during operation. Since the input ports 1406 comprise downpipes 304 inclusive of one or more port holes 306, any liquid or wet material may be pulled downward via the forces of gravity into the bottom of one or more tanks. As negative pressure is achieved and/or maintained within the chamber defined by the one or more tanks, any liquid may rest along a bottom edge of the tank with a substantial distance between the 90 degree elbow joints 116 and the liquid.

The output port 1408 may further be releasably coupled to a vacuum system and therefore any additional distance away from liquid or aerosolized liquids may serve to protect the vacuum system. Additionally, the input ports 1406 may be coupled to other vacuum liquid separators or other vacuum systems that may not require keeping a filter dry for example.

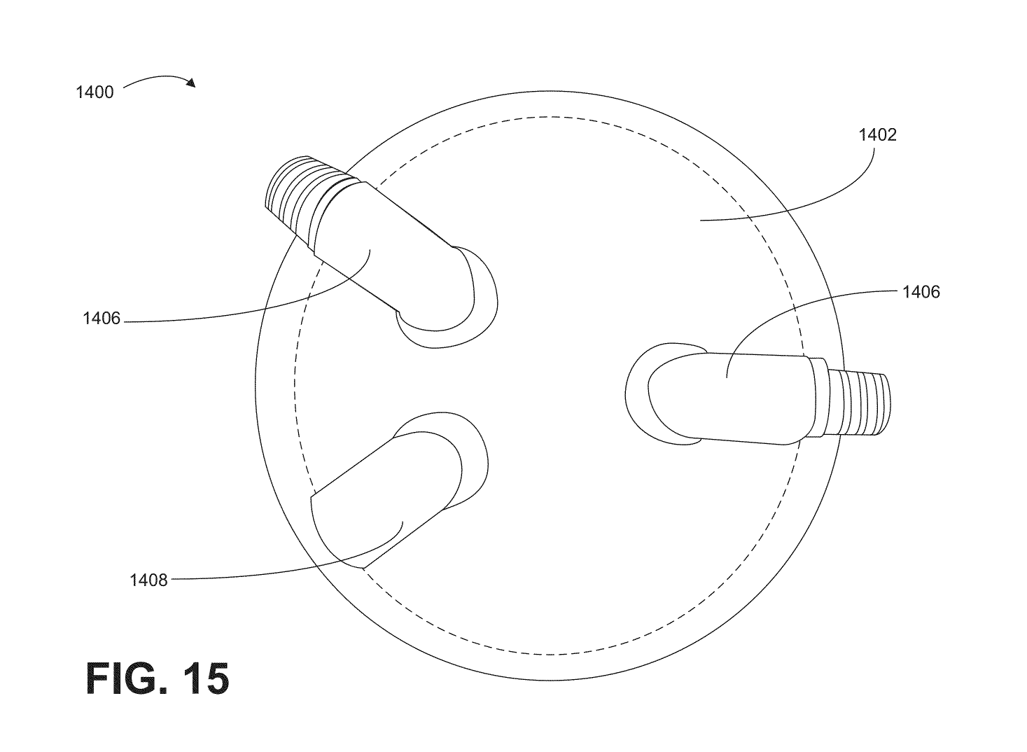

As illustrated in FIG. 15, one or more embodiments of a vacuum liquid separator may comprise more than one input port 1406 and an output port 1408. The output port 1408 may be coupled to a vacuum system in at least one embodiment. Further, the output port 1408 may not include a downpipe, but downpipes may be coupled to the input ports 1406. In this way, the flow going to or toward the vacuum system may be further separated from liquid or aerosolized liquid and the input ports 1406 may serve to provide one or more flows of liquid or damp material. In providing an output port 1408 that does not comprise a downpipe, the vacuum system providing the negative pressure and/or the vacuum filter may be protected from excess liquid contact.

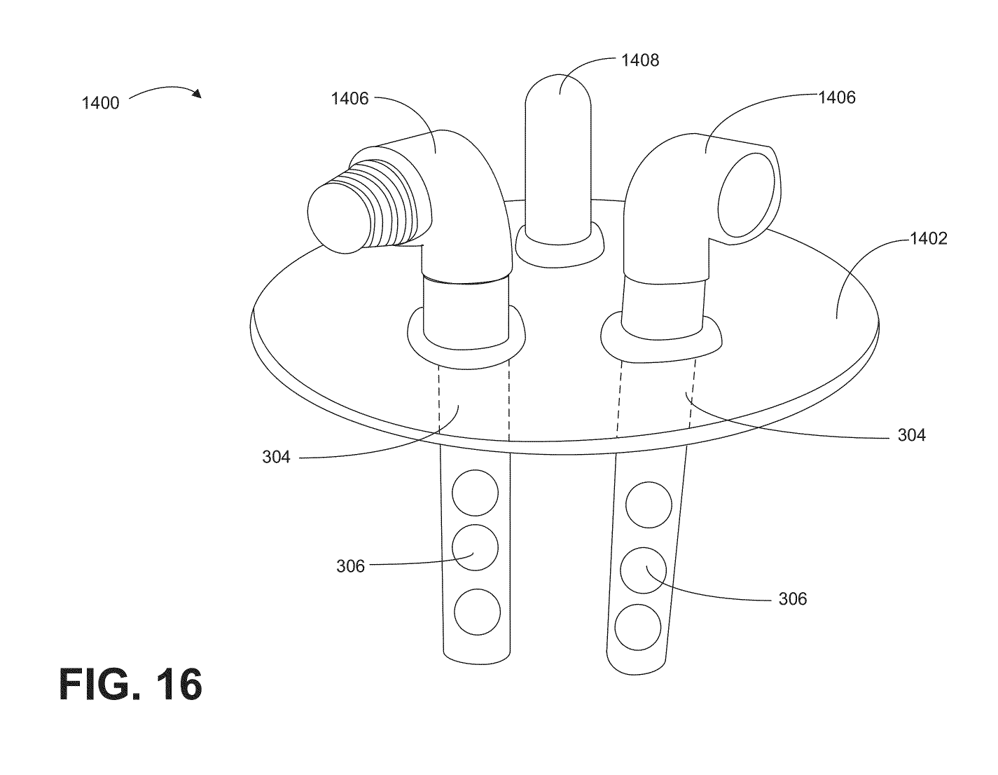

In FIG. 16, the downpipes 304 are shown coupled to each of two provided input ports 1406. The downpipes may serve to reduce the amount of water that splashes up inside the one or more tanks. Further, the port holes 306 that line a side face of the downpipes 304 may be directed toward an interior surface of the tank. In this way, any liquid that comes through the input port 1406 may be contained, at least to some degree, prior to reaching the bottom of the tank. This precaution of directing the port holes 306 away from the output port 1408 may further server to reduce an amount of liquid that may splash up or aerosolize within the vacuum chamber.

FIGS. 1-16 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from one another with only a space there-between and no other components may be referred to as such in at least one example. As yet another example, elements shown above or below one another, at opposite sides relative to one another, or to the left or right of one another may be referred to as such, relative to one another. Further, as shown in the figures, a topmost element or point of an element may be referred to as a “top” of the component and a bottommost element or point of an element may be referred to as a “bottom” of the component in at least one example.

As used herein, top/bottom, upper/lower, above/below, may be relative to a vertical axis of the figures and may be used to describe positioning of elements of the figures relative to one another. As such, elements shown above other elements are positioned vertically above the other elements in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred to as such in at least one example.

It will be appreciated that the configurations and/or approaches described herein are exemplary in nature, and that these specific embodiments or examples are not to be considered in a limiting sense, because numerous variations are possible. The subject matter of the present disclosure includes all novel and nonobvious combinations and sub combinations of the various features, functions, acts, and/or properties disclosed herein, as well as any and all equivalents thereof.

The following claims particularly point out certain combinations and sub combinations of the present subject matter regarded as novel and nonobvious. These claims may refer to “an” element or “a first” element or the equivalent thereof. Such claims should be understood to include incorporation of one or more such elements, neither requiring nor excluding two or more such elements. Other combinations and sub combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A vacuum liquid separator for use with a wet/dry vacuum system comprising:
one or more tanks for retaining captured material;
a cover releasably coupled to the one or more tanks comprising an output port, at least one input port further comprising an elongated downpipe extending downward into the one or more tanks; and
a manifold system comprising at least two 90 degree fittings that fully traverse a top horizontal planar surface of the cover on one end and are coupled to one another on the other end by a crossover pipe,
wherein the manifold system communicatively couples the one or more tanks to each other.

2. The vacuum liquid separator of claim 1, wherein the cover comprises a substantially rectangular shape.

3. The vacuum liquid separator of claim 1, wherein the cover is coupled to the one or more tanks defining one or more airtight chambers.

4. The vacuum liquid separator of claim 1, wherein the downpipe of the at least one input port includes one or more port holes for restricting percolation of liquid within the one or more tanks.

5. The vacuum liquid separator of claim 1, wherein the at least one input port and the output port are directed facing away from one another.

6. The vacuum liquid separator of claim 1, wherein the output port and the at least one input port are disposed along the top horizontal planar surface of the cover.

7. The vacuum liquid separator of claim 1, wherein the output port and the at least one input port further comprise 90 degree fittings that fully traverse a top horizontal planar surface of the cover.

8. The vacuum liquid separator of claim 7, wherein the 90 degree fittings are directed away from the center of the cover.

9. The vacuum liquid separator of claim 7, wherein the output port and the at least one input port include barbed fittings for selectively coupling the liquid separator to hoses or a vacuum system.

10. The vacuum liquid separator of claim 9, wherein the barbed fittings of each 90 degree fitting are disposed within an end of each 90 degree fitting that is directed away from the center of the cover.

11. The vacuum liquid separator of claim 1, wherein the cover is one of plastic, plexiglass, or metal.

12. The vacuum liquid separator of claim 1, wherein the one or more tanks are plastic, PVC, or metal.

13. The vacuum liquid separator of claim 1, wherein the manifold system is schedule 40 PVC.

14. A vacuum liquid separator comprising:
a cover including one or more output ports, one or more input ports further comprising one or more elongated downpipes fully traversing the cover and extending downward; and
one or more tanks for retaining captured material releasably coupled to the cover.

15. The vacuum liquid separator of claim 14 wherein the one or more elongated downpipes further comprise one or more port holes for controlling percolation of liquid within the one or more tanks.

16. The vacuum liquid separator of claim 14, wherein the one or more output ports and the one or more input ports are disposed along a top horizontal planar surface of the cover.

17. The vacuum liquid separator of claim 14, wherein the cover comprises a substantially circular shape.

18. The vacuum liquid separator of claim 14, wherein the cover is coupled to the one or more tanks defining one or more airtight chambers.

19. The vacuum liquid separator of claim 14, wherein the cover is plastic, plexiglass, or metal.

20. The vacuum liquid separator of claim 14, wherein the one or more tanks are plastic, PVC, or metal.
